(19) United States
(12) Patent Application Publication
(10) Pub. No.: US 2025/0309973 A1
(43) Pub. Date: Oct. 2, 2025

(54) DIRECTIONAL BEAM DETERMINATION TOWARDS A USER EQUIPMENT

(71) Applicant: Telefonaktiebolaget LM Ericsson (publ), Stockholm (SE)

(72) Inventors: Behrooz MAKKI, Pixbo (SE); Magnus ÅSTRÖM, Lund (SE); Andreas NILSSON, Göteborg (SE)

(73) Assignee: Telefonaktiebolaget LM Ericsson (publ), Stockholm (SE)

(21) Appl. No.: 18/861,080

(22) PCT Filed: Apr. 29, 2022
(86) PCT No.: PCT/EP2022/061561

§ 371 Date: Oct. 28, 2024

(51) Int. Cl. H04B 7/155; H04B 7/04; H04B 17/318

(52) U.S. Cl. CPC H04B 7/15528; H04B 7/04013; H04B 17/328

(57) ABSTRACT

There is provided mechanisms for directional beam determination towards a user equipment. A method is performed by a network node. The network node determines that the user equipment is served a the reflector node. The network node selects the directional beam to be used by the reflector node for subsequent communication between the network node and the user equipment via the reflector node. The network node configures the reflector node such that the selected directional beam is used. The network node communicates with the user equipment via the reflector node once the reflector node has been configured.

### TECHNICAL FIELD

Embodiments presented herein relate to a method, a network node, a computer program, and a computer program product for directional beam determination towards a user equipment.

### BACKGROUND

Millimeter waves (mmWaves) corresponding to carrier frequencies above 10 GHz have been introduced for the new radio (NR) air interface as used in fifth generation (5G) telecommunication systems. However, communication over mmWaves is sensible to blocking, i.e. physical objects blocking the radio waves. A non-limiting example illustrating blocking and its effects will now be disclosed with reference to FIG. 1. FIG. 1 shows an example of a communications network 100. The communication network 100 comprises a network node 200 (for example provided as a (radio) access network node) that is configured to provide network access to user equipment, one of which is shown at reference numeral 140. As illustrated in the figure, the direct, or line-of-sight (LOS) path between the between network node 200 and the user equipment 140 is blocked by a physical object 120. Communication between the network node 200 and the user equipment 140 is therefore relayed via a reflector node 110 on an indirect path 130a, 130b having a first part 130a (between the network node 200 and the reflector node 110) and a second part (between the reflector node 110 and the user equipment 140).

In this respect, the reflector node 110 constitutes part of a smart radio environment. In this respect, one technique enabling the creation of smart radio environments involves the use of surfaces that can interact with the radio environment. As disclosed in, for example, “Smart Radio Environments Empowered by AI Reconfigurable Meta-Surfaces: An Idea Whose Time Has Come” by Marco Di Renzo et al., as accessible on https://arxiv.org/abs/1903.08925 (latest accessed 11 Apr. 2022), “Reconfigurable-Intelligent-Surface Empowered Wireless Communications: Challenges and Opportunities” by Xiaojun Yuan et al., as accessible on https://arxiv.org/abs/2001.00364 (latest accessed 11 Apr. 2022), and “Intelligent Reflecting Surface Enhanced Wireless Network via Joint Active and Passive Beamforming” by Q. Wu and R. Zhang, in IEEE Transactions on Wireless Communications, vol. 18, no. 11, pp. 5394-549 November 2019, doi: 10.1109/TWC.2019.2936025 such surfaces are commonly called meta-surfaces, reconfigurable intelligent surfaces, large intelligent surfaces, intelligent reconfigurable surfaces, or repeater modules and represent an emerging technology that is capable of intelligently manipulating the propagation of electro-magnetic waves. Without loss of generality or discrimination between these terms, the term repeater module will be used throughout this disclosure.

FIG. 2 is a schematic illustration of a reflector node 110. The reflector node 110 comprises a controller module 112 and a repeater module 118, comprising a meta-surface or other type of array structure with patch antennas. In turn, the controller module 112 comprises, or houses, a controller 114 for controlling the reflection angle of the repeater module 118 for reflecting radio waves over an indirect link 130a, 130b between the network node 200 and the user equipment 140. The controller module 112 further comprises, or houses, a transceiver unit 116 for receiving instructions from the network node 200 over a control channel 120 regarding how the reflection angle of the repeater module 118 is to be controlled. In further detail, by the controller 114 controlling the impedances of the respective patch antennas, the reflection angle of an incoming radio wave can be adapted according to the generalized Snell's law. In some examples, the reflector node 110 is a network-controlled repeater. As the skilled person understand, FIG. 2 only illustrates one example implementation of the reflector node 110 and the implementation might differ dependent on the type of reflector node 110. For example, a network-controlled repeater might have a different implementation, but the general concept is the same, namely that the network-controlled repeater will cause a impinging beam to be reflected in a controllable direction.

Thus, with reference back to the example of FIG. 1, if the reflector node 110 is provided with a passive repeater module and a controller module, the reflection of a signal transmitted by the network node 200 could be controlled such that the signal does reach the user equipment 140 via a non-line of sight signal paths corresponding to the indirect path 130a, 130b. However, to correctly reflect signals at the reflector node 110 when beamformed communication is used becomes a non-trivial task.

### SUMMARY

An object of embodiments herein is to address the above issues by providing techniques for efficiently directional beam determination.

According to a first aspect there is presented a method for directional beam determination towards a user equipment. The method is performed by a network node. The network node serves the user equipment in a radio environment over at least one indirect path via a reflector node. The method comprises configuring the reflector node with an ordered set of reflection directions for the reflector node to sequentially in time, and in a first set of time slots, change its reflection direction in accordance with the ordered set of reflection directions. The reflection directions correspond to a set of directional beams, with one directional beam per reflection direction. The method comprises transmitting a burst of reference signal resources towards the reflector node in the first set of time slots, wherein one reference signal resource is transmitted per each of the directional beams. The method comprises receiving a report indicative at least of which of the transmitted reference signal resources was received at the user equipment with highest reference signal received power. The method comprises selecting the directional beam corresponding to the reference signal resource received by the user equipment with highest reference signal received power. The method comprises configuring the reflector node to use the reflection direction corresponding to the selected directional beam for subsequent communication with the user equipment.

According to a second aspect there is presented a network node for directional beam determination towards a user equipment. The network node is configured to serve the user equipment in a radio environment over at least one indirect path via a reflector node. The network node comprises processing circuitry. The processing circuitry is configured to cause the network node to configure the reflector node with an ordered set of reflection directions for the reflector node to sequentially in time, and in a first set of time slots, change its reflection direction in accordance with the ordered set of reflection directions. The reflection directions correspond to a set of directional beams, with one directional beam per reflection direction. The processing circuitry is configured to cause the network node to transmit a burst of reference signal resources towards the reflector node in the first set of time slots, wherein one reference signal resource is transmitted per each of the directional beams. The processing circuitry is configured to cause the network node to receive a report indicative at least of which of the transmitted reference signal resources was received at the user equipment with highest reference signal received power. The processing circuitry is configured to cause the network node to select the directional beam corresponding to the reference signal resource received by the user equipment with highest reference signal received power. The processing circuitry is configured to cause the network node to configure the reflector node to use the reflection direction corresponding to the selected directional beam for subsequent communication with the user equipment.

According to a third aspect there is presented a network node for directional beam determination towards a user equipment. The network node is configured to serve the user equipment in a radio environment over at least one indirect path via a reflector node. The network node comprises a configure module configured to configure the reflector node with an ordered set of reflection directions for the reflector node to sequentially in time, and in a first set of time slots, change its reflection direction in accordance with the ordered set of reflection directions. The reflection directions correspond to a set of directional beams, with one directional beam per reflection direction. The network node comprises a transmit module configured to transmit a burst of reference signal resources towards the reflector node in the first set of time slots, wherein one reference signal resource is transmitted per each of the directional beams. The network node comprises a receive module configured to receive a report indicative at least of which of the transmitted reference signal resources was received at the user equipment with highest reference signal received power. The network node comprises a select module configured to select the directional beam corresponding to the reference signal resource received by the user equipment with highest reference signal received power. The network node comprises a configure module configured to configure the reflector node to use the reflection direction corresponding to the selected directional beam for subsequent communication with the user equipment.

According to a fourth aspect there is presented a computer program for directional beam determination towards a user equipment, the computer program comprising computer program code which, when run on a network node, causes the network node to perform a method according to the first aspect.

According to a fifth aspect there is presented a computer program product comprising a computer program according to the fourth aspect and a computer readable storage medium on which the computer program is stored. The computer readable storage medium could be a non-transitory computer readable storage medium.

Advantageously, these aspects provide efficient beam management procedures in smart radio environments comprising one or more reflector nodes.

Particularly, these aspects enable the integration of one or more reflector nodes into the network and thereby improve the coverage extension.

Advantageously, in this way, one or more reflector nodes can be configured to help bypassing blockages, thus avoiding performance drop (such as beam link failure) of the user equipment.

Advantageously, this results in coverage extension and a fairly constant Quality-of-Service (QOS) experience for the user equipment.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIGS. 1, 4, and 5 are schematic diagrams illustrating a communications network according to embodiments;

FIG. 2 is a schematic illustration of a reflector node according to an embodiment;

FIGS. 3 and 6 are flowchart of methods according to embodiments;

FIG. 7 is a schematic diagram showing functional units of a network node according to an embodiment;

FIG. 8 is a schematic diagram showing functional modules of a network node according to an embodiment; and

FIG. 9 shows one example of a computer program product comprising computer readable storage medium according to an embodiment.

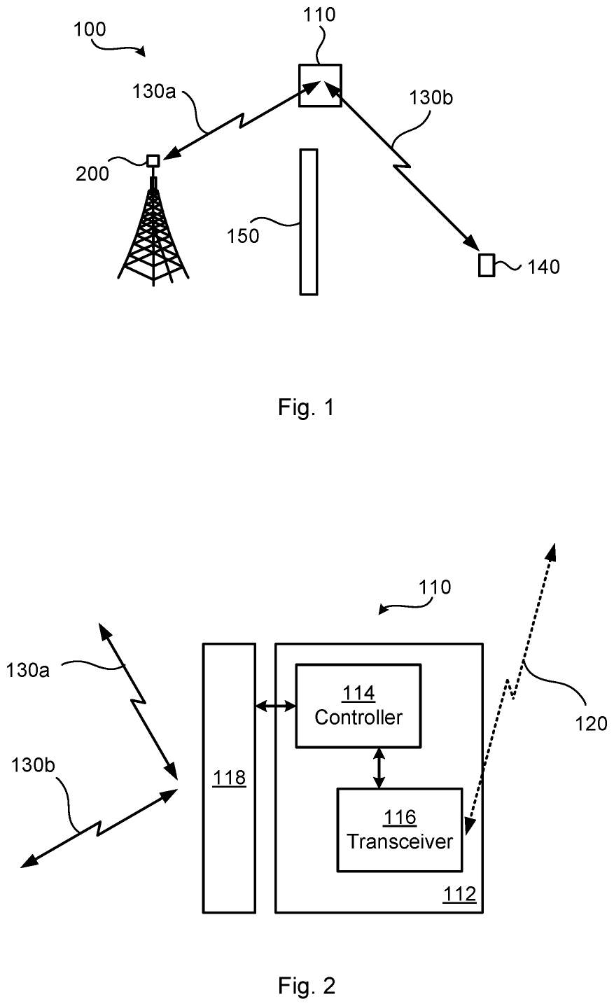

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

As noted above, to correctly reflect signals at the reflector node 110 when beamformed communication is used becomes a non-trivial task

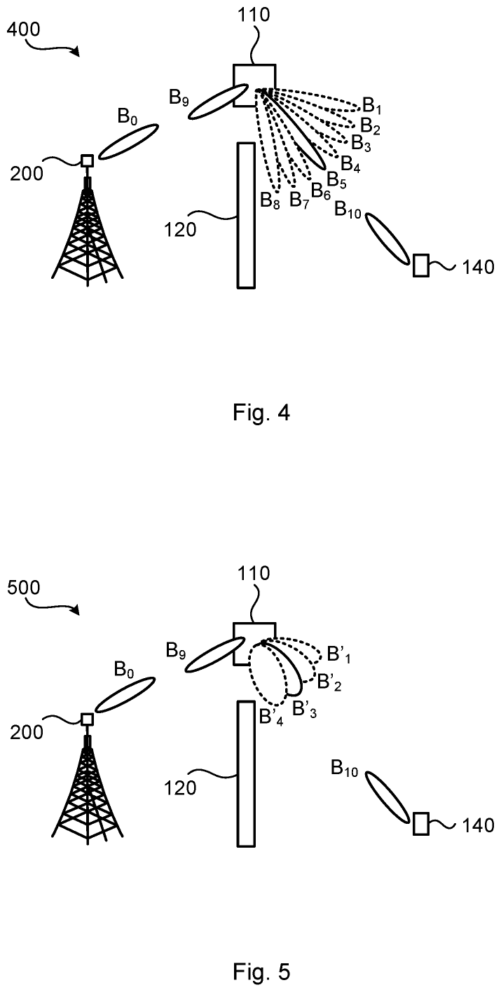

Therefore, according to embodiments disclosed herein, to benefit from reflector nodes 110, existing beam management procedures are adapted to network deployments with reflector nodes 110. Particularly, different from, e.g., integrated access and backhaul (IAB) nodes or user equipment 140, which receive signals from a parent node as an end point, reflector nodes 110 are configured to directly forward any received signal with some power amplification and/or phase rotation with some power amplification and change of direction based on manipulation (as implemented by reflector nodes 110) of the received signal. To guarantee the required coverage extension, beams between different nodes and/or devices should be aligned for each of the two links (or hops), i.e., both for the link 130a between the network node 200 and the reflector node 110 and for the link 130b between the reflector node 110 and the user equipment 140. Since the reflector nodes 110 is assumed to be fixed in position, if beamforming is used for the link 130a between the network node 200 and the reflector node 110 (see, e.g., the beams B0 and B9 in FIGS. 4 and 5), these beams only need to be determined once (during e.g., initialization of the reflector node 110). However, since the user equipment 140 served by the network node 200 via a reflector node 110 can be located at different positions, and move around, the beam used by the reflector node 110 for the link 130b between the reflector node 110 and the user equipment 140 needs to be dynamically determined and updated. How to dynamically determine and control the beam used by the reflector node 110 for the link 130b between the reflector node 110 and the user equipment 140 is still an open issue.

The embodiments disclosed herein therefore relate to techniques for directional beam determination towards a user equipment 140. In order to obtain such techniques there is provided a network node 200, a method performed by the network node 200, a computer program product comprising code, for example in the form of a computer program, that when run on a network node 200, causes the network node 200 to perform the method.

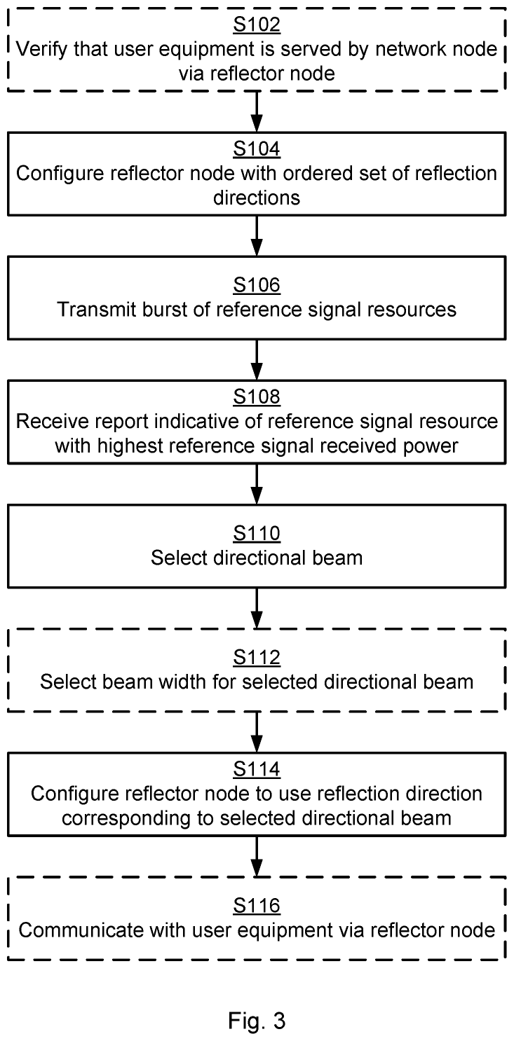

FIG. 3 is a flowchart illustrating embodiments of methods for directional beam determination towards a user equipment 140. The methods are performed by the network node 200. The network node 200 is configured to serve the user equipment 140 in a radio environment over at least one indirect path 130a, 130b via a reflector node 110. The methods are advantageously provided as computer programs 920.

S104: The network node 200 configures the reflector node 110 with an ordered set of reflection directions for the reflector node 110 to sequentially in time, and in a first set of time slots, changes its reflection direction in accordance with the ordered set of reflection directions. The reflection directions correspond to a set of directional beams B1:B8, B′1:B′4, with one directional beam B1:B8, B′1:B′4 per reflection direction.

S106: The network node 200 transmits a burst of reference signal resources towards the reflector node 110 in the first set of time slots. One reference signal resource is transmitted per each of the directional beams B1:B8, B′1:B′4.

S108: The network node 200 receives a report indicative at least of which of the transmitted reference signal resources was received at the user equipment 140 with highest reference signal received power.

S110: The network node 200 selects the directional beam B5, B′3 corresponding to the reference signal resource received by the user equipment 140 with highest reference signal received power.

S114: The network node 200 configures the reflector node 110 to use the reflection direction corresponding to the selected directional beam B5, B′3 for subsequent communication with the user equipment 140.

Embodiments relating to further details of directional beam determination towards a user equipment 140 as performed by the network node 200 will now be disclosed.

There could be different types of reference signal resources, and thus reference signals transmitted by the network node 200 in step S106. In some examples, the reference signal resources are channel state information reference signal (CSI-RS) resources or synchronization signal block (SSB) resources.

There could be different ways in which the reference signal resources are transmitted. In some examples, the reference signal resources are transmitted as millimeter wave (mmW) signals.

Aspects of how the network node 200 might determine that the user equipment 140 is served via the reflector node 110 will be disclosed next.

In some aspects, the network node 200 actively determines that the user equipment 140 is served via the reflector node 110. In particular, in some embodiments, the network node 200 is configured to perform (optional) step S102.

S102: The network node 200 verifies that the user equipment 140 is served by the network node 200 via the reflector node 110 before configuring the reflector node 110 and before transmitting the burst of reference signal resources.

In one aspect, the network node 200 verifies that a user equipment 140 is operatively connected to the network node 200 via the reflector node 110 by analysing random access signalling received from the user equipment 140. The random access signalling might be a random access attempt as transmitted by the user equipment 140 on a physical random access channel (PRACH). In case the random access signalling is associated with an SSB transmitted in a beam, B0, that is pointing towards the reflector node 110, the network node 200 may assume that the user equipment 140 is operatively connected to the network node 200 via the reflector node 110.

In one alternative of this aspect the random access signalling is transmitted during initial access of the user equipment 140, handover of the user equipment 140, or as part of radio link recovery or beam failure recovery procedures for the user equipment 140.

In another alternative of this aspect, or in combination with the above, the received power of the random access signalling is also analysed by the network node 200 to help with identifying if the user equipment 140 is connected to the network node 200 via the reflector node 110 or not. For example, it could be so that the user equipment 140 is served in a beam pointing towards the reflector node 110, but where the user equipment 140 still is operatively connected directly to the network node 200. For example, the random access signalling received by a reflector node 110 might be received with higher power compared to a user equipment 140 not served via the reflector node 110, and only if the random access signalling is received with a power over a certain threshold, the user equipment 140 is assumed to be served via the reflector node 110.

In one alternative of this aspect, or in combination with the above, the received timing of the random access signalling is also analysed by the network node 200 to help with identifying if the user equipment 140 is operatively connected via the reflector node 110 or not. For example, a user equipment 140 operatively connected via the reflector node 110 might have a longer path, and hence higher time delay, compared to a user equipment 140 directly operatively connected to the network node 200. For example, in case the estimated time delay of the random access signalling (or other uplink transmission from the user equipment 140) is above a certain threshold time limit, the user equipment 140 is by the network node 200 assumed to be operatively connected via the reflector node 110.

In one aspect, the network node 200 verifies that a user equipment 140 is operatively connected to the network node 200 via the reflector node 110 by analysing a beam report received from the user equipment 140. For example, in case the strongest reported beam in a beam report is a beam that is pointing towards the reflector node 110, the network node 200 may assume that the user equipment 140 is operatively connected via the reflector node 110.

In one alternative of this aspect, the network node 200 analyses other aspects, such as reference signal received power (RSRP), provided in the beam report, uplink RSRP measured on uplink signals received from the user equipment 140, timing advance, etc. to further help with identifying if the user equipment 140 is operatively connected via the reflector node 110 or not.

In another alternative of this aspect, the network node 200 analyses all reported beams in a beam report to further help with identifying if the user equipment 140 is operatively connected via the reflector node 110 or not. For example, a user equipment 140 that is operatively connected via a reflector node 110 (for example an indoor user equipment 140 connected via an outdoor-to-indoor reflector node 110), might have very poor reception for beams as generated by the network node 200 that are not pointing directly towards the reflector node 110. Thus, in case the beam report reveals very poor RSRP for all beams except for the beam pointing towards the reflector node 110 node, then the network node 200 assumes that the user equipment 140 is operatively connected via the reflector node 110. Alternatively, the network node 200 may use the fact that a user equipment 140 served via the reflector node 110 is likely to report different RSRP values for different beams used by the reflector node 110 whereas this would not be the case for a user equipment 140 not served via the reflector node 110.

Aspects of how the network node 200 might select the directional beam B5, B′3 to be used by the reflector node 110 for subsequent communication between the network node 200 and the user equipment 140 via the reflector node 110 will now be disclosed.

In one aspect, the network node 200 determines a suitable reflector node 110 beam by triggering the user equipment 140 with a reflector node based P2 beam sweep.

In particular, in some embodiments, the reflector node 110 is configured to sequentially in time change the reflection direction of the reflector node 110 in accordance with the ordered set of reflection directions by the network node 200 configuring the reflector node 110 to perform a beam sweep through the directional beams B1:B8, B′1:B′4. One example of a reflector node 110 based P2 beam is illustrated in FIG. 4. In some embodiments, the network node 200 configures the reflector node 110 to receive the reference signal resources from the network node 200 in a fixed beam B9 directed towards the network node 200. In FIG. 4. the network node 200 has configured the reflector node 110 with a fixed reflector node beam B9 for the link between the network node 200 and the reflector node 110 link, and also configured the reflector node 110 to perform a beam sweep in beams B1-B8.

The network node 200 then transmits a burst of reference signal resources (configured for example in a CSI-RS resource set with ‘repetition’=‘off’) in a fixed network node beam B0 towards the reflector node 110. Hence, in some embodiments, the burst of reference signal resources is part of a reference signal resource set without any repetition, and wherein all reference signal resources are transmitted in one and the same beam B0 from the network node 200. The reflector node 110 is configured such that one reference signal resource is transmitted in each reflector node beam B1-B8 during the reflector node beam sweep. The user equipment 140 will perform measurements on the received reference signal resources and report the N best reference signal resource indices (such as CSI resource indices; CRIs). Since each reference signal resource index will be associated with one respective reflector node beam, the network node 200 can determine a preferred reflector node beam. In FIG. 4, the preferred, and thus selected, reflector node beam is beam B5. Another example of a reflector node 110 based P2 beam is illustrated in FIG. 5. In FIG. 5. the network node 200 has configured the reflector node 110 with a fixed reflector node beam B9 for the link between the network node 200 and the reflector node 110 link, and also configured the reflector node 110 to perform a beam sweep in beams B1′-B4′. In FIG. 4, the preferred, and thus selected, reflector node beam is beam B3′. FIGS. 4 and 5 are different with respect to each other in terms of the beam width in which the beam sweep is performed at the reflector node 110. In this respect, the beams B1-B8 in FIG. 4 are narrower than the beams B1′-B4′ in FIG. 5. FIG. 4 represents a scenario where the reference signal resources might be channel state information reference signal resources whereas FIG. 5 represents a scenario where the reference signal resources might be synchronization signal block resources.

Aspects of how the network node 200 might configure the reflector node 110 such that the selected directional beam B5, B′3 is used.

In one aspect, the configuration of the reflector node 110 is in S114 signalled directly from the network node 200 to the reflector node 110. In another aspect, the configuration of the reflector node 110 is in S114 signalled via another network node to the reflector node 110

In one aspect the configuration comprises a beam index, where the beam index corresponds to a specific antenna weight matrix that is applied to the antenna array of the reflector node 110. Hence, in some embodiments, the network node 200 configures the reflector node 110 to use the reflection direction corresponding to the selected directional beam B5, B′3 by the network node 200 providing a beam index of the selected directional beam B5, B′3 to the reflector node 110. In one alternative of such embodiments, one beam index is signalled per polarization. This could be useful in case different beams are optimal for two different polarizations of the antenna array.

In one aspect, the configuration comprises an output power value, which indicates how much output power the reflector node 110 should apply.

In one aspect, the configuration comprises timing information that indicates during which time slots the beam index and/or output power should be applied. Hence, in some embodiments, the network node 200 configures the reflector node 110 to use the reflection direction corresponding to the selected directional beam B5, B′3 in a second set of time slots.

In one aspect the configuration depends on if unicast, or multicast or broadcast communication should be conveyed by the reflector node 110. In particular, in some embodiments, the network node 200 is configured to perform (optional) step S112.

S112: The network node 200 selects a beam width for the selected directional beam B5, B′3. The beam width differs depending on whether communication with the user equipment 140 in the second set of time slots is unicast, multicast, or broadcast communication.

In case unicast transmission is applied by the network node 200, a beam index corresponding to a narrow reflector node beam (pointing towards a specific user equipment 140) might be included in the configuration. In case multicast/broadcast transmission is applied by the network node 200, a beam index corresponding to a wide reflector node beam (covering the whole coverage area of the reflector node 110) might be included in the configuration. In case multicast/broadcast transmission is applied by the network node 200, the configuration might indicate an increased output power level, to compensate for the lower antenna gain due to wide reflector node beam. Hence, in some embodiments, the beam width is narrower for uncast communication than for multicast, or broadcast communication.

In one aspect, the configuration is restricted to downlink only, or uplink only, or for a certain number of slots, or a combination of uplink, downlink, and slots. In one aspect, the configuration is restricted to a certain channel, e.g., a control channel such as the physical downlink control channel (PDCCH) and/or the physical uplink control channel (PUCCH), or a data channel such as the physical downlink shared channel (PDSCH) or the physical uplink shared channel (PUSCH), etc.

Aspects of how the network node 200 might communicate with the user equipment 140 via the reflector node 110 once the reflector node 110 has been configured will now be disclosed.

In particular, in some embodiments, the network node 200 is configured to perform (optional) step S116.

S116: The network node 200 communicates with the user equipment 140 via the reflector node 110 in the second set of time slots.

In one aspect, the network node 200 performs power control by beam forming, such that a lower transmit power is achieved by using a wider but less focused beam, whilst a higher transmit power is achieved by using a more narrow but more focused beam.

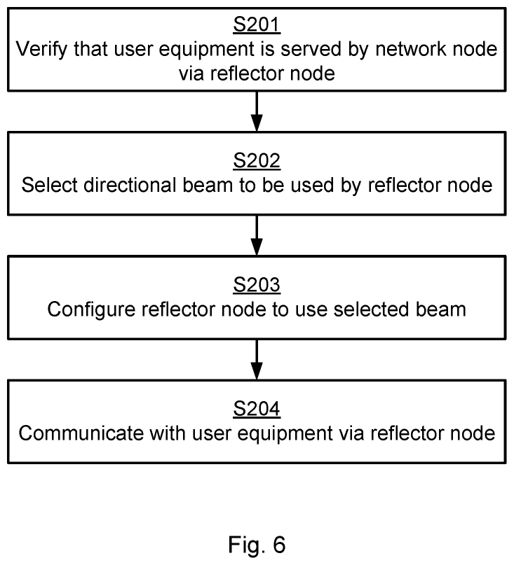

On particular embodiment for directional beam determination towards a user equipment 140 as performed by the network node 200 based on at least some of the above disclosed embodiments will be disclosed next with reference to the flowchart of FIG. 6.

S201: The network node 200 verifies that the user equipment 140 is served via the reflector node 110.

S202: The network node 200 selects the directional beam B5, B′3 to be used by the reflector node 110 for subsequent communication between the network node 200 and the user equipment 140 via the reflector node 110.

S203: The network node 200 configures the reflector node 110 such that the selected directional beam B5, B′3 is used.

S204: The network node 200 communicates with the user equipment 140 via the reflector node 110 once the reflector node 110 has been configured.

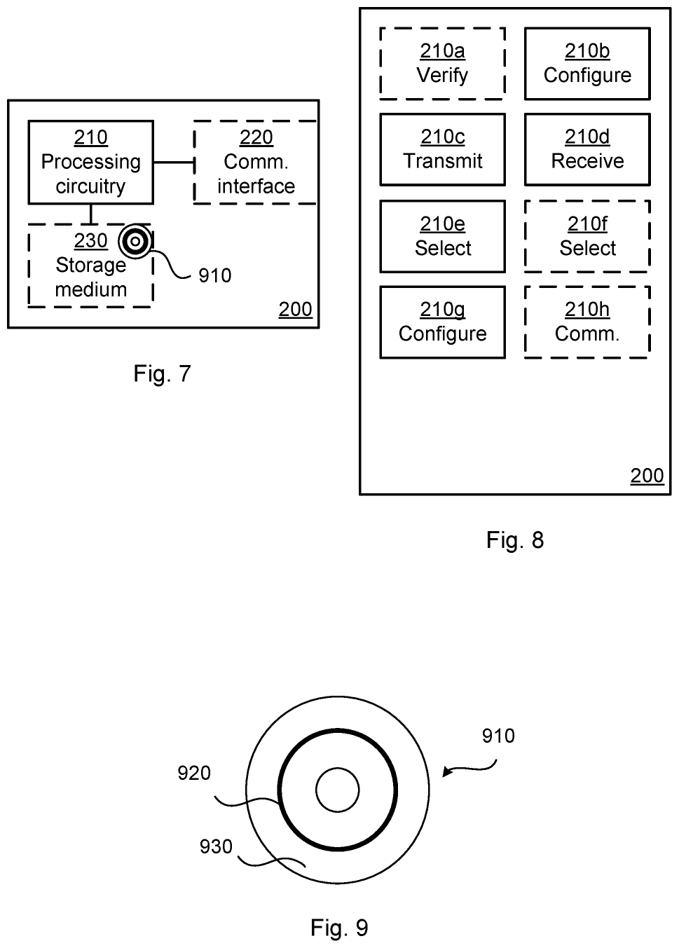

FIG. 7 schematically illustrates, in terms of a number of functional units, the components of a network node 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 910 (as in FIG. 9), e.g. in the form of a storage medium 230. The processing circuitry 210 may further be provided as at least one application specific integrated circuit (ASIC), or field programmable gate array (FPGA).

Particularly, the processing circuitry 210 is configured to cause the network node 200 to perform a set of operations, or steps, as disclosed above. For example, the storage medium 230 may store the set of operations, and the processing circuitry 210 may be configured to retrieve the set of operations from the storage medium 230 to cause the network node 200 to perform the set of operations. The set of operations may be provided as a set of executable instructions.

Thus the processing circuitry 210 is thereby arranged to execute methods as herein disclosed. The storage medium 230 may also comprise persistent storage, which, for example, can be any single one or combination of magnetic memory, optical memory, solid state memory or even remotely mounted memory. The network node 200 may further comprise a communications interface 220 at least configured for communications with other entities, functions, nodes, and devices, such as the user equipment 140 and the controller module 112 of the reflector node 110. As such the communications interface 220 may comprise one or more transmitters and receivers, comprising analogue and digital components. The processing circuitry 210 controls the general operation of the network node 200 e.g. by sending data and control signals to the communications interface 220 and the storage medium 230, by receiving data and reports from the communications interface 220, and by retrieving data and instructions from the storage medium 230. Other components, as well as the related functionality, of the network node 200 are omitted in order not to obscure the concepts presented herein.

FIG. 8 schematically illustrates, in terms of a number of functional modules, the components of a network node 200 according to an embodiment. The network node 200 of FIG. 8 comprises a number of functional modules; a configure module 210b configured to perform step S104, a transmit module 210c configured to perform step S106, a receive module 210d configured to perform step S108, a select module 210e configured to perform step S110, and a configure module 210g configured to perform step S114. The network node 200 of FIG. 8 may further comprise a number of optional functional modules, such as any of a verify module 210a configured to perform step S102, a select module 210f configured to perform step S112, and a communicate module 210h configured to perform step S116.

In general terms, each functional module 210a:210h may in one embodiment be implemented only in hardware and in another embodiment with the help of software, i.e., the latter embodiment having computer program instructions stored on the storage medium 230 which when run on the processing circuitry makes the network node 200 perform the corresponding steps mentioned above in conjunction with FIG. 8. It should also be mentioned that even though the modules correspond to parts of a computer program, they do not need to be separate modules therein, but the way in which they are implemented in software is dependent on the programming language used. Preferably, one or more or all functional modules 210a:210h may be implemented by the processing circuitry 210, possibly in cooperation with the communications interface 220 and/or the storage medium 230. The processing circuitry 210 may thus be configured to from the storage medium 230 fetch instructions as provided by a functional module 210a:210h and to execute these instructions, thereby performing any steps as disclosed herein.

The network node 200 may be provided as a standalone device or as a part of at least one further device. For example, the network node 200 may be provided in a node of the radio access network or in a node of the core network. Alternatively, functionality of the network node 200 may be distributed between at least two devices, or nodes. These at least two nodes, or devices, may either be part of the same network part (such as the radio access network or the core network) or may be spread between at least two such network parts. In general terms, instructions that are required to be performed in real time may be performed in a device, or node, operatively closer to the cell than instructions that are not required to be performed in real time. Thus, a first portion of the instructions performed by the network node 200 may be executed in a first device, and a second portion of the of the instructions performed by the network node 200 may be executed in a second device; the herein disclosed embodiments are not limited to any particular number of devices on which the instructions performed by the network node 200 may be executed. Hence, the methods according to the herein disclosed embodiments are suitable to be performed by a network node 200 residing in a cloud computational environment. Therefore, although a single processing circuitry 210 is illustrated in FIG. 7 the processing circuitry 210 may be distributed among a plurality of devices, or nodes. The same applies to the functional modules 210a:210h of FIG. 8 and the computer program 920 of FIG. 9.

FIG. 9 shows one example of a computer program product 910 comprising computer readable storage medium 930. On this computer readable storage medium 930, a computer program 920 can be stored, which computer program 920 can cause the processing circuitry 210 and thereto operatively coupled entities and devices, such as the communications interface 220 and the storage medium 230, to execute methods according to embodiments described herein. The computer program 920 and/or computer program product 910 may thus provide means for performing any steps as herein disclosed.

In the example of FIG. 9, the computer program product 910 is illustrated as an optical disc, such as a CD (compact disc) or a DVD (digital versatile disc) or a Blu-Ray disc. The computer program product 910 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 920 is here schematically shown as a track on the depicted optical disk, the computer program 920 can be stored in any way which is suitable for the computer program product 910.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for directional beam determination towards a user equipment, wherein the method is performed by a network node, wherein the network node serves the user equipment in a radio environment over at least one indirect path via a reflector node, the method comprising:
configuring the reflector node with an ordered set of reflection directions for the reflector node to sequentially in time, and in a first set of time slots, change its reflection direction in accordance with the ordered set of reflection directions, wherein the reflection directions correspond to a set of directional beams, with one directional beam per reflection direction;
transmitting a burst of reference signal resources towards the reflector node in the first set of time slots, wherein one reference signal resource is transmitted per each of the directional beams;
receiving a report indicative at least of which of the transmitted reference signal resources was received at the user equipment with highest reference signal received power;
selecting the directional beam corresponding to the reference signal resource received by the user equipment with highest reference signal received power; and
configuring the reflector node to use the reflection direction corresponding to the selected directional beam for subsequent communication with the user equipment.

2. The method of claim 1, wherein the method further comprises:
verifying that the user equipment is served by the network node via the reflector node before configuring the reflector node and before transmitting the burst of reference signal resources.

3. The method of claim 1, wherein the reflector node is configured to sequentially in time change the reflection direction of the reflector node in accordance with the ordered set of reflection directions by the network node configuring the reflector node to perform a beam sweep through the directional beams.

4. The method of claim 1, wherein the burst of reference signal resources is part of a reference signal resource set without any repetition, and wherein all reference signal resources are transmitted in one and the same beam from the network node.

5. The method of claim 1, wherein the network node configures the reflector node to receive the reference signal resources from the network node in a fixed beam directed towards the network node.

6. The method of claim 1, wherein the network node configures the reflector node to use the reflection direction corresponding to the selected directional beam by the network node providing a beam index of the selected directional beam to the reflector node.

7. The method of claim 1, wherein the network node configures the reflector node to use the reflection direction corresponding to the selected directional beam in a second set of time slots.

8. The method of claim 7, wherein the method further comprises:
communicating with the user equipment via the reflector node in the second set of time slots.

9. The method of claim 7, wherein the method further comprises:
selecting a beam width for the selected directional beam, wherein the beam width differs depending on whether communication with the user equipment in the second set of time slots is unicast, multicast, or broadcast communication.

10. The method of claim 9, wherein the beam width is narrower for uncast communication than for multicast, or broadcast communication.

11. The method of claim 1, wherein the reference signal resources are channel state information reference signal, CSI-RS, resources or synchronization signal block, SSB, resources.

12. The method of claim 1, wherein the reference signal resources are transmitted as millimeter wave signals.

13. The method of claim 1, wherein the reflector node is a network-controlled repeater or a reconfigurable intelligent surface.

14. A network node for directional beam determination towards a user equipment, wherein the network node is configured to serve the user equipment in a radio environment over at least one indirect path via a reflector node, the network node comprising:
memory; and
processing circuitry, the processing circuitry being configured to cause the network node to:
configure the reflector node with an ordered set of reflection directions for the reflector node to sequentially in time, and in a first set of time slots, change its reflection direction in accordance with the ordered set of reflection directions, wherein the reflection directions correspond to a set of directional beams, with one directional beam per reflection direction; and
transmit a burst of reference signal resources towards the reflector node in the first set of time slots, wherein one reference signal resource is transmitted per each of the directional beams;
select, based on a received report indicative at least of which of the transmitted reference signal resources was received at the user equipment with highest reference signal received power, the directional beam corresponding to the reference signal resource received by the user equipment with highest reference signal received power; and
configure the reflector node to use the reflection direction corresponding to the selected directional beam for subsequent communication with the user equipment.

15. The network node of claim 14, wherein the network node is further configured to verify that the user equipment is served by the network node via the reflector node before configuring the reflector node and before transmitting the burst of reference signal resources.

16. The network node of claim 14 wherein the burst of reference signal resources is part of a reference signal resource set without any repetition, and wherein all reference signal resources are transmitted in one and the same beam from the network node.

17. A non-transitory computer readable storage medium storing a computer program for directional beam determination towards a user equipment, the computer program comprising computer code which, when run on processing circuitry of a network node configured to serve the user equipment in a radio environment over at least one indirect path via a reflector node, causes the network node to:
configure the reflector node with an ordered set of reflection directions for the reflector node to sequentially in time, and in a first set of time slots, change its reflection direction in accordance with the ordered set of reflection directions, wherein the reflection directions correspond to a set of directional beams, with one directional beam per reflection direction;
transmit a burst of reference signal resources towards the reflector node in the first set of time slots, wherein one reference signal resource is transmitted per each of the directional beams;
select, based on a report indicative at least of which of the transmitted reference signal resources was received at the user equipment with highest reference signal received power, the directional beam corresponding to the reference signal resource received by the user equipment with highest reference signal received power; and
configure the reflector node to use the reflection direction corresponding to the selected directional beam for subsequent communication with the user equipment.

18. (canceled)
